(19) United States
(12) Patent Application Publication
(10) Pub. No.: US 2012/0101181 A1
(43) Pub. Date: Apr. 26, 2012

(54) NATURAL OIL BASED POLYMER POLYOLS AND POLYURETHANE PRODUCTS MADE THEREFROM

(75) Inventors: Imran Munshi, Au (CH); Paul Cookson, Samstagern (CH)

(73) Assignee: Dow Global Technologies LLC, Midland, MI (US)

(21) Appl. No.: 13/379,090

(22) PCT Filed: Jun. 9, 2010
(86) PCT No.: PCT/US2010/037941

§ 371 Date: Dec. 19, 2011

Related U.S. Application Data
(60) Provisional application No. 61/220,237, filed on Jun. 25, 2009.

(51) Int. Cl. C08L 75/04; C08J 9/00; C08L 75/02; C08L 33/18; C08L 33/12; C08L 33/20; C08L 25/06

(52) U.S. Cl. 521/157; 524/565; 524/589; 524/577; 524/560; 521/163; 521/176

(57) ABSTRACT

A polymer polyol composition having dispersed polymer particles in a continuous phase which includes at least one polyether natural oil based polyol comprising at least two natural oil moieties separated by at least one of a molecular structure having an average of at least about 19 ether groups between any 2 of the natural oil moieties and a polyether molecular structure having an equivalent weight of at least about 400. The polymer polyol composition may be used in forming polyurethane foams.

### BACKGROUND

1. Field of the Invention

Embodiments of the present invention generally relate to polyurethane production; more specifically to polymer-modified polyols useful in polyurethane production.

2. Description of the Related Art

Polyurethane foams are produced by the reaction of polyisocyanates and polyols. In order to improve load-bearing and other foam properties, so-called polymer polyol products have been developed. A common type of polymer polyol is a dispersion of vinyl polymer particles in a polyol. Examples of vinyl polymer particle polyols include so-called “SAN” polyols, which are dispersions of styrene-acrylonitrile. Other common types of polymer polyols are so-called “PHD” polyols (dispersions of polyurea particles) and so-called “PIPA” (polyisocyanate polyaddition) polyols (dispersions of polyurethane-urea particles). PIPA and PHD particles may be produced by introducing the appropriate monomer or monomers into a conventional petroleum-based polyol or polyol blend and reacting the monomer(s) with an isocyanate in order to polymerize the monomer(s).

Conventional polyol prices tend to fluctuate with crude oil pricing, which is becoming increasingly volatile due to dwindling proven reserves, increased global demand, and an uncertain geopolitical climate. It may therefore be desirable to replace conventional petroleum-based polyols with an alternative polyol that is based on a renewable feedstock.

Therefore, there is a need for a method of producing polyurethane foams that result in an increased amount of renewable resources in the final polyurethane product.

### SUMMARY

The embodiments of the present invention satisfy the needs for producing polyurethane foams that result in an increased amount of renewable resources in the final polyurethane product while also keeping desired properties of the polyurethane product. For example, described herein is a method for preparing a polyurethane foam that has a high concentration of renewable resources while retaining the load-bearing properties and improving the humid ageing properties of the final polyurethane foam.

In one embodiment of the invention, a polymer polyol, including a polyol and dispersed polymer particles is provided, the polyol includes at least one polyether natural oil based polyol with at least two natural oil moieties separated by at least one of a molecular structure having an average of at least about 19 ether groups between any 2 of the natural oil moieties and a polyether molecular structure having an equivalent weight of at least about 400.

In another embodiment, a polymer polyol, including a polyol and dispersed polymer particles is provided, the polyol includes at least one polyether natural oil based polyol with at least two natural oil moieties separated by at least one of a molecular structure having an average of at least about 19 ether groups between any 2 of the natural oil moieties and a polyether molecular structure having an equivalent weight of at least about 480.

In another embodiment, a polyurethane foam is provided. The polyurethane foam is the reaction product of at least an isocyanate and a polymer polyol. The polymer polyol includes a polyol and dispersed polymer particles. The polyol includes at least one polyether natural oil based polyol with at least two natural oil moieties separated by at least one of a molecular structure having an average of at least about 19 ether groups between any 2 of the natural oil moieties and a polyether molecular structure having an equivalent weight of at least about 400 or 480.

In another embodiment, a polyurethane foam is provided. The polyurethane foam includes a reaction product of at least an isocyanate and a polyol. The polyurethane foam has a resilience of at least about 50% and a humid aged hardness loss of less than about 40%, in accordance to DIN EN ISO 2440.

In another embodiment, a method for forming a polymer polyol is provided. The method includes providing a polyol composition having at least one polyether natural oil based polyol with at least two natural oil moieties separated by at least one of a molecular structure having an average of at least about 19 ether groups between any 2 of the natural oil moieties and a polyether molecular structure having an equivalent weight of at least about 400, and forming at least one polymer particle population of at least one of acrylonitrile, polystyrene, methacrylonitrile, methyl methacrylate, styrene-acrylonitrile, polyurea, and polyurethane-urea in the polyol composition.

### DETAILED DESCRIPTION

Embodiments of the present invention provide a polymer polyol made using natural oil based polyols. These natural oil based polymer polyols (NOBPP) may be used in producing polyurethane products, such as foams, which have a high concentration of renewable resources. These products may retain the same level of load-bearing properties as products based on conventional, non-renewable, resources. Additionally, these may also demonstrate improved humid ageing properties. The natural oil based polymer polyols (NOBPP) may be prepared by in situ polymerization of polymer particles in a polyol blend.

The polyol blend includes at least one polyether natural oil based polyol (PNOBP). The PNOBP may include at least two natural oil moieties separated by a molecular structure having an average of at least about 19 ether groups between any 2 of the natural oil moieties or by a polyether molecular structure having an equivalent weight of at least about 400.

The PNOBP may be made by reacting an initiator with a natural oil or derivative thereof, such as a natural oil based monomer such as is described in WO2004096882 which is hereby incorporated herein by reference. The initiator may have at least one active hydrogen, which is reacted with the natural oil based monomer, and has sufficient ether groups to render it more compatible or miscible with water, conventional polyether polyols or a combination thereof or to improve processibility or physical properties. Such initiators are referred to herein as polyether initiators, and includes amine tipped polyethers. In one embodiment, a PNOBP is made with an initiator or combination of initiators having an average equivalent weight of between about 400 and about 3000 per active hydrogen group. All individual values and subranges between about 400 and about 3000 per active hydrogen group are included herein and disclosed herein; for example, the average equivalent weight can be from a lower limit of about 400, 450, 480, 500, 550, 600, 650, 700, 800, 900, 1000, 1200, or 1300 to an upper limit of about 1500, 1750, 2000, 2250, 2500, 2750, or 3000 per active hydrogen group.

Thus, at least two of the natural oil based monomers are separated by a molecular structure having an average molecular weight of between about 1250 Daltons and about 6000 Daltons. All individual values and subranges between about 1250 Daltons and about 6000 Daltons are included herein and disclosed herein; for example, the average molecular weight can be from a lower limit of about 1250, 1500, 1750, 2000, 2250, 2500, 2750, 3000, or Daltons to an upper limit of about 3000, 3500, 4000, 4500, 5000, 5500, or 6000 Daltons.

In one embodiment, these characteristics are achieved using a single initiator, optionally with those impurities present in commercial products. In an alternative embodiment, the characteristics are achieved using combinations (referred to hereinafter as blends, mixtures or admixtures) of initiators in making the PNOBP and/or in combinations of natural oil based monomers. In either combination, at least about 10, at least about 15, at least about 20, preferably at least about 25, or at least about 30 weight percent (mass fraction) of the initiator used has an equivalent weight of at least about 400. When more than one initiator is used, the PNOBPs may be prepared separately with the resulting products combined in physical blends, used together in the same reaction to form insitu combinations, or a combination thereof.

The ether groups may be in poly(alkylene oxide) chains, such as in poly(propylene oxide) or poly(ethylene oxide) or a combination thereof. In one embodiment, the ether groups may be in a diblock structure of poly(propylene oxide) capped with poly(ethylene oxide).

The active hydrogen group is optionally any active hydrogen group that is sufficiently reactive to react with the natural oil or derivatives thereof under reaction conditions, and each active hydrogen group may be independently a hydroxyl or amine group. For example, the active hydrogen group may be a hydroxyl group. In one embodiment the hydroxyl group may be a primary hydroxyl group. In the case of amine groups, primary and secondary amines may be used. Of the active hydrogen groups, at least about 50, 60, 70, 80, 85, 90, or up to 100 mole percent of these groups are primary hydroxyl groups or amine groups. In one embodiment, these amounts of primary hydroxyl groups in the initiator may also be the amounts of primary hydroxyl group in the PNOBP produced.

Thus the initiators may be depicted by Formula 1:

R((OCH₂CHY)_{b}—XH)ₚ

where Y is a H, CH₃ or higher alkyl group (preferably C1 to C16, preferably C1 to C8, or preferably C1 to C4) or mixture thereof; X is an active hydrogen group, independently preferably O, N, or NH, or preferably O; p is 1 to 8, preferably 2 to 8; b is sufficient to result in an equivalent weight per active hydrogen group of at least about 400, preferably at least about 7 to a most about 70. The number of ether units in an arm of the polyether initiator, b, may be at least about 9, or at least about 12, when the equivalent weight is at least about 400, but at least about 13, at least about 14, or at least about 15, when the equivalent weight is less than about 400; and regardless of equivalent weight, b is independently may be at most about 70, at most about 55, or at most about 45, such on average, the equivalent weight of the compound of Formula 1 is at least about 400, or on average each active hydrogen is separated from each other active hydrogen by an average of 19 ether groups (—OCH₂CHY—), preferably both. In the formula, each X is optionally the same or different. The initiator, therefore, encompasses polyols, polyamines and aminoalcohols. R generally represents a linear, cyclic chain or combination thereof of alkane (C—C), alkene (C═C), ether (C—O—C) linkages or combinations thereof. R may have at least about 1, at least about 2, or at least about 3, and independently preferably has at most about 36, at most about 24, or at most about 12 carbon atoms. The carbon atoms within the aforementioned chain are optionally substituted with a methyl or ethyl group. It should be noted that the value of each b in a polyether initiator optionally is the same or varies from one OCH₂CHY)_{b}—XH chain or “arm” of the polyether initiator to another. Furthermore, those skilled in the art will recognize that there will be variations in the numbers of alkylene oxide molecules added to a molecule in a reaction, thus in the value of b with in a molecule of polyether initiator and among molecules prepared simultaneously. To allow for variations, values of b previously listed are understood to be the average b over all chains of the polyether initiator or combination thereof.

The R group is optionally exemplified by polyol initiators for polyethers that include neopentylglycol; 1,2-propylene glycol; trimethylolpropane; pentaerythritol; sorbitol; sucrose; glycerol; alkanediols such as 1,6-hexanediol; 2,5-hexanediol; 1,4-butanediol; 1,4-cyclohexane diol; ethylene glycol; diethylene glycol; triethylene glycol; 9(1)-hydroxymethyloctadecanol, 1,4-bishydroxymethylcyclohexane; 8,8-bis(hydroxymethyl)tricyclo[5,2,1,02,6]decene; Dimerol alcohol (36 carbon diol available from Henkel Corporation); hydrogenated bisphenol; 9,9(10,10)-bishydroxymethyloctadecanol; 1,2,6-hexanetriol; any of the aforementioned where at least one of the alcohol or amine groups present therein has been reacted with ethylene oxide, propylene oxide or mixture thereof; and combination thereof.

Exemplary polyamines that can form the R group of Formula 1 include ethylene diamine; neopentyldiamine, 1,6-diaminohexane; bisaminomethyltricyclodecane; bisaminocyclohexane; diethylene triamine; bis-3-aminopropyl methylamine; and triethylene tetramine. Exemplary aminoalcohols include ethanolamine, diethanolamine, and triethanolamine. Other compounds that are optionally used include polyols, polyamines or aminoalcohols described in U.S. Pat. Nos. 4,216,344; 4,243,818 and 4,348,543 and British Pat. No. 1,043,507.

Preferably, the initiator that forms R may be selected from the group consisting of neopentylglycol; trimethylolpropane; pentaerythritol; sorbitol; sucrose; glycerol; 1,2-propylene glycol; 1,6-hexanediol; 2,5-hexanediol; 1,6-hexanediol; 1,4-cyclohexane diol; 1,4-butanediol; ethylene glycol; diethylene glycol; triethylene glycol; bis-3-aminopropyl methylamine; ethylene diamine; diethylene triamine; 9(1)-hydroxymethyloctadecanol; 1,4-bishydroxymethylcyclohexane; 8,8-bis(hydroxymethyl)tricyclo[5,2,1,02,6]decene; Dimerol alcohol; hydrogenated bisphenol; 9,9(10,10)-bishydroxymethyloctadecanol; 1,2,6-hexanetriol; any of the aforementioned where at least one of the alcohol or amine groups present therein has been reacted with ethylene oxide, propylene oxide or mixture thereof; and combination thereof.

Then, to form the polyether initiator, the active hydrogen groups may be reacted with at least one alkylene oxide, such ethylene oxide or propylene oxide or a combination thereof; or a block of propylene oxide followed by a block of ethylene oxide, to form a polyether polyol by means within the skill in the art. The polyether polyol is may be used as a polyol for reaction with at least one natural oil or derivative thereof or with at least one natural oil based monomer. Alternatively the polyol is reacted by means within the skill in the art to convert one or more hydroxyl groups to alternative active hydrogen groups, such as is propylene oxide.

The polyether initiator is reacted with at least one natural oil or derivative thereof, such as at least one natural oil based monomer such as is described in WO2004096882. The natural oil or derivative thereof is optionally any natural oil or derivative of a natural oil reactive with at least one active hydrogen group on a polyether initiator according to the practice of the embodiments of the invention. Preferably the natural oil or derivative thereof has at least one acid, anhydride, acid chloride, or ester group reactive with at least one active hydrogen group on a polyether initiator to form at least one ester or amide. The natural oils or derivatives thereof are exemplified by natural oil based monomers herein, but the exemplification is not intended to limit the embodiments of the invention to the natural oil based monomers.

The natural oil based monomer or other fatty acid or derivative thereof is optionally formed from of any animal fat or vegetable oil that is comprised of triglycerides that upon saponification with a base such as aqueous sodium hydroxide yields a fatty acid and glycerol, where at least a portion of the fatty acids are preferably unsaturated fatty acids (that is, contain at least one carbon double bond). Preferred vegetable oils are those that yield at least about 70 percent unsaturated fatty acids by weight. More preferably, the vegetable oil yields at least about 85 percent, at least 87 percent, or at least about 90 percent by weight unsaturated fatty acids. It is understood that specific fatty acids derivable from a vegetable oil, animal fat or any other source are optionally used. That is to say, for example, palmitoleic, oleic, linoleic, linolenic and arachidonic fatty acid alkyl esters are optionally used to form the natural oil based monomer directly. Examples of suitable vegetable oils include, for example, those from castor, soybean, olive, peanut, rapeseed, corn, sesame, cotton, canola, safflower, linseed, palm, grapeseed, black caraway, pumpkin kernel, borage seed, wood germ, apricot kernel, pistachio, almond, macadamia nut, avocado, sea buckthorn, hemp, hazelnut, evening primrose, wild rose, thistle, walnut, sunflower, jatropha seed oils, or a combination thereof. Additionally, oils obtained from organisms such as algae may also be used. Examples of animal products include lard, beef tallow, fish oils and mixtures thereof. A combination of vegetable and animal based oils/fats may also be used. It is understood that the vegetable oil is optionally obtained from a genetically modified organism, such as genetically modified soybean, sunflower or canola.

Unsaturated fatty acid alkyl esters may then be formed, by any suitable process such as those known in the art, into preferred natural oil based monomers. For example, the hydroxymethyl group is optionally introduced by a hydroformylation process using a cobalt or rhodium catalyst followed by the hydrogenation of the formyl group to obtain the hydroxymethyl group by catalytic or by chemical reduction. Procedures to form the hydroxymethyl esters are described in U.S. Pat. Nos. 4,216,343; 4,216,344; 4,304,945 and 4,229,562 and in particular 4,083,816. Other known processes to form hydroxymethyl esters from fatty acids may also be used such as described by U.S. Pat. Nos. 2,3324,849 and 3,787,459.

In forming the natural oil based monomers, fatty acid alkyl esters are optionally completely formylated or only partially formylated. That is to say, the fatty acid alkyl esters of the particular vegetable oil optionally have some remaining unsaturated (C═C) bonds. Preferably, however, the amount of unsaturated bonds remaining after formylation is as described in WO2004096744, incorporated herein by reference. After the fatty acid alkyl esters are formylated they may be hydrogenated, such that there is desirably essentially no remaining unsaturated bonds (that is, trace amounts at most and preferably no detectable amounts of unsaturation).

At least one natural oil or derivative thereof and at least one polyether initiator are reacted together by any suitable means such as those known in the art to form at least one PNOBP. For example, the method is taught in WO200496882 and WO2004096883, which are incorporated herein by reference. The natural oil moiety may optionally be reacted with the initiator before or after functionalization, that is, formation or introduction of hydroxyl groups or their precursors to the fatty acid moieties.

In an embodiment, a functionalized natural oil moiety is formed, and then is reacted with a polyether initiator by any means within the skill in the art, for instance, transesterification, wherein an ester linkage is formed by reaction of a polyether initiator with the methyl ester of a functionalized fatty acid or, alternatively by esterification of an acid, chloride or anhydride form of the natural oil or derivative. The natural oil moiety of this embodiment is optionally functionalized by any means within the skill in the art, for example by epoxidation (and ring opening), amination, reacting with such compounds as maleic anhydride or perchloric acid, air oxidation, ozonolysis, hydroformylation, reaction with water such as blown oils where moist air in the presence of a catalyst preferably by epoxidation or hydroformylation.

In an alternative embodiment, the natural oil based monomer may be an unsaturated fatty acid unit in the acid form or in the methyl ester form. This monomer unit is optionally reacted with the polyether initiator (or combination thereof) using the same chemistry used for reaction with the functionalized natural oil based monomer. After this natural oil based monomer is reacted with the polyether initiator; it is then functionalized by any reaction within the skill in the art, such as those listed for functionalization before reaction with the polyether initiator. The functional group is directly useful for the formation of polyurethanes, or optionally undergoes further chemical reaction to form a useful functional group, such as the ring opening of an epoxy functional group to form the a NOP useful for such purposes.

The resulting PNOBP, comprises at least two natural oil moieties separated by a molecular structure having at least about 19 ether groups or having an equivalent weight of at least about 400, preferably both. When the polyether initiator has more than 2 active hydrogen groups reactive with the natural oil or derivative thereof, each natural oil moiety is separated from another by an average of at least about 19 ether groups or a structure of molecular weight of at least about 400, preferably both.

Thus, the PNOBP's are represented by Formula 2:

R(OCH₂CHY)_{b}XQ)ₚ,

wherein R, X, b, and p are as defined for Formula 1 and each Q independently represents at least one natural oil moiety. The Q's of a molecule are optionally the same or different. Q advantageously has the structure of at least one natural oil or, of one or more fatty acids or derivatives thereof, or at least one hydroxy functional fatty acid or derivative thereof, or at least one hydroxymethyl methyl fatty acid or derivative thereof. Q may also represent a series of fatty acid derivatives, most preferably oligomerized by esterification or transesterification of at least one hydroxyl group or ester group, preferably the hydroxyl of a hydroxymethyl group on each fatty acid derivative with the acid or ester (preferably methyl ester) of another fatty acid derivative molecule or molecular portion. Preferably at least about an average of 0.5, 0.8, or 1 fatty acid are oligomerized to form each natural oil moiety, Q. The number of fatty acid or fatty acid derivatives in each Q is preferably at most about 8, at most about 5, or at most about 3.

The polyol blend may optionally include at least one conventional petroleum-based polyol material having at least one group containing an active hydrogen atom capable of undergoing reaction with an isocyanate, and not having parts of the material derived from a vegetable or animal oil. Preferred among such compounds are materials having at least two hydroxyls, primary or secondary, or at least two amines, primary or secondary, carboxylic acid, or thiol groups per molecule. Compounds having at least two hydroxyl groups or at least two amine groups per molecule are especially preferred due to their desirable reactivity with polyisocyanates.

Suitable conventional petroleum-based polyols are well known in the art and include those described herein and any other commercially available polyol. Mixtures of one or more polyols and/or one or more copolymer polyols may also be used to produce polyurethane products according to the present invention.

Representative polyols include polyether polyols, polyester polyols, polyhydroxy-terminated acetal resins, hydroxyl-terminated amines and polyamines. Alternative polyols that may be used include polyalkylene carbonate-based polyols and polyphosphate-based polyols. Preferred are polyols prepared by adding an alkylene oxide, such as ethylene oxide, propylene oxide, butylene oxide or a combination thereof, to an initiator having from 2 to 8, preferably 2 to 6 active hydrogen atoms. Catalysis for this polymerization can be either anionic or cationic, with catalysts such as KOH, CsOH, boron trifluoride, or a double cyanide complex (DMC) catalyst such as zinc hexacyanocobaltate or quaternary phosphazenium compound.

Examples of suitable initiator molecules are water, organic dicarboxylic acids, such as succinic acid, adipic acid, phthalic acid and terephthalic acid; and polyhydric, in particular dihydric to octohydric alcohols or dialkylene glycols.

Exemplary polyol initiators include, for example, ethanediol, 1,2- and 1,3-propanediol, diethylene glycol, dipropylene glycol, 1,4-butanediol, 1,6-hexanediol, glycerol, pentaerythritol, sorbitol, sucrose, neopentylglycol; 1,2-propylene glycol; trimethylolpropane glycerol; 1,6-hexanediol; 2,5-hexanediol; 1,4-butanediol; 1,4-cyclohexane diol; ethylene glycol; diethylene glycol; triethylene glycol; 9(1)-hydroxymethyloctadecanol, 1,4-bishydroxymethylcyclohexane; 8,8-bis(hydroxymethyl)tricyclo[5,2,1,0^{2.6}]decene; Dimerol alcohol (36 carbon diol available from Henkel Corporation); hydrogenated bisphenol; 9,9(10,10)-bishydroxymethyloctadecanol; 1,2,6-hexanetriol; and combination thereof.

The conventional petroleum-based polyols may for example be poly(propylene oxide) homopolymers, random copolymers of propylene oxide and ethylene oxide in which the poly(ethylene oxide) content is, for example, from about 1 to about 30% by weight, ethylene oxide-capped poly(propylene oxide) polymers and ethylene oxide-capped random copolymers of propylene oxide and ethylene oxide. For slabstock foam applications, such polyethers preferably contain 2-5, especially 2-4, and preferably from 2-3, mainly secondary hydroxyl groups per molecule and have an equivalent weight per hydroxyl group of from about 400 to about 3000, especially from about 800 to about 1750. For high resiliency slabstock and molded foam applications, such polyethers preferably contain 2-6, especially 2-4, mainly primary hydroxyl groups per molecule and have an equivalent weight per hydroxyl group of from about 1000 to about 3000, especially from about 1200 to about 2000. When blends of polyols are used, the nominal average functionality (number of hydroxyl groups per molecule) will be preferably in the ranges specified above. For viscoelastic foams shorter chain polyols with hydroxyl numbers above 150 are also used. For the production of semi-rigid foams, it is preferred to use a trifunctional polyol with a hydroxyl number of 30 to 80.

The PNOBP may constitute at least 10%, at least 25%, at least at least 35%, at least 50%, at least 65%, at least 70%, at least 75%, at least 80%, at least 85%, at least 90%, at least 95%, at least 96%, at least 97%, at least 98%, or at least 99%, of the total weight of the polyol blend. The PNOBP may constitute 50% or more, 60% or more, 65% or more, 70% or more, 75% or more, 85% or more, 90% or more, 95% or more, 96% or more, 97% or more, 98% or more, 99% or more, or even 100% of the total weight of polyol blend.

Polymer particles may be prepared by in situ polymerization of polymer monomers in the polyol blend. The particles may be, for example, a polymer of one or more vinyl monomers, or may be polyurea or polyurea-urethane particles.

To produce a dispersion of vinyl polymer particles, one or more ethylenically unsaturated monomers and at least one stabilizer, both as described more fully below, are dispersed in a continuous polyol phase. In general, the polymerization is conducted by forming an agitated mixture of the monomer in the continuous phase, and subjecting the mixture to conditions sufficient to polymerize the monomer to form dispersed polymer particles. Conditions suitable for conducting such polymerizations are well known and described, for example, in WO 2006/065345 and WO 2008/005708, the contents of which are herein incorporated by reference.

Suitable ethylenically unsaturated monomers are those which are polymerizable at a temperature at which the continuous phase does not significantly degrade (such as at temperature of below 150° C., especially below 130° C.), and which have low solubility in the polyol blend when polymerized. Examples of suitable monomers include aliphatic conjugated dienes such as butadiene; monovinylidene aromatics such as styrene, α-methyl styrene, vinyl naphthalene and other inertly substituted styrenes; α,β-ethylenically unsaturated carboxylic acids and esters such as acrylic acid, methacrylic acid, methyl acrylate, methyl methacrylate, 2-hydroxyethyl acrylate and 2-hydroxyethyl methacrylate; α,β-ethylenically unsaturated nitriles such as acrylonitrile; acrylamide; vinyl esters such as vinyl acetate; vinyl ethers; vinyl ketones; vinyl and vinylidene halides; and the like. Of these, the monovinyl aromatics and α,β-unsaturated nitriles are preferred. Styrene and acrylonitrile are preferred monomers. Mixtures of styrene and acrylonitrile (SAN) may be preferred, especially mixtures in which styrene constitutes from about 25 to 95%, especially from about 50 to 75%, of the weight of the monomer mixture.

One class of stabilizers for producing vinyl polymer particles includes macromers that are compatible with the polyol blend (i.e., form a single-phase mixture with the polyol blend at the relative proportions that are present) and which contain polymerizable ethylenic unsaturation. The macromers may include a polyether portion, which is typically a polymer of propylene oxide and/or ethylene oxide. The polymer is capped with a difunctional capping agent that has a hydroxyl-reactive group and ethylenic unsaturation. Examples of such capping agents include isocyanates, carboxylic acids, carboxylic acid halides, carboxylic acid anhydrides and epoxies having ethylenic unsaturation, and hydroxyl-reactive silanes such as vinyl trimethoxysilane. The macromer may have a number average molecular weight of about 2000-50,000, preferably about 8,000 to about 15,000. The macromer may contain an average of from about 1 to about 7 or more hydroxyl groups/molecule. A macromer of particular interest has a number average molecular weight of about 8,000 to 15,000 and an average of no more than 1.0 hydroxyl group/molecule. Another macromer of particular interest has a number average molecular weight of about 8,000 to 15,000 and an average of 3-7 hydroxyl groups/molecule.

Another suitable class of stabilizers includes polyethers having a molecular weight of about 5,000 to about 50,000, especially about 8,000 to about 15,000, which do not contain added ethylenically polymerizable unsaturation. These stabilizers are conveniently prepared by reacting a lower molecular weight polyether polyol with a coupling agent, such as a polyioscyanate, certain silanes having two or more hydroxyl-reactive groups (such as alkoxyl groups), polyepoxides, polycarboxylic acids or the corresponding acid halides and anhydrides, and the like.

The vinyl polymer particles may be prepared by combining the monomer(s), stabilizer and polyol blend with agitation to form a mixture, and subjecting the mixture to polymerization conditions. It is possible to add all components to the reaction vessel at the start of the reaction, and it is possible to add monomers and stabilizer to the reaction vessel continuously or in stages during the reaction. When a macromer-type stabilizer is used, a small amount of the monomers may be polymerized before beginning the main monomer feed. The stabilizer may be added in a rate roughly proportional to the rate of growth of the surface area of the dispersed particles.

The polymerization may be conducted in the presence of a free radical initiator. The amount of the free radical initiator is selected to provide a commercially reasonable reaction rate while controlling exotherms. A typical amount of free radical initiator is from about 0.1 to about 5, preferably about 0.2 to about 2 and more preferably from about 0.25 to about 1% by weight, based on monomers. The free radical initiator may be all added at the start of the reaction, or it may be added continuously or in stages during the reaction (particularly when the monomer is so added). Examples of suitable free radical initiators include peroxyesters, peroxides, persulfates, perborates, percarbonates, azo compounds and the like. Specific examples of suitable free radical initiators include hydrogen peroxide, t-butyl peroctoate, di(t-butyl)peroxide, lauroyl peroxide, cumene hydroperoxide, t-butyl hydroperoxide, 2,2′-azobis [2,4-dimethyl]pentanenitrile, 2-(t-butylazo)-2-methylbutane nitrile, 2-(t-butylazo)-2-4, dimethylpentanenitrile, azobis (isobutyronitrile), azobis(methylbutyronitrile) (AMBN), tert-amyl peroxy 2-ethyl hexanoate and mixtures of any two or more thereof.

The polymerization to form vinyl polymer particles may be conducted in the presence of a chain transfer agent, as the use of these materials in some cases improves the stability and filterability of the polymer polyol product. Suitable such chain transfer agents include mercaptans such as tertiary dodecyl mercaptan, α-toluenethiol, 1-tetradecanethiol, 2-octanethiol, 1-heptanethio, 1-octanethiol, 2-naphthalenethiol, 1-naphthalenethiol, 1-hexanethiol, ethanethio, and 1-dodecanethiol. Other suitable chain transfer agents include benzyl sulfide, iodoform, iodine, and the like. Suitable amounts of chain transfer agent are from about 0.1 to about 5, especially from about 0.25 to about 2.5 and preferably from about 0.5 to about 1%, based on the weight of the monomers.

To produce a dispersion of polyurethane-urea particles (PIPA) or urea particles (PHD) in the polyol blend, PIPA or PHD forming monomer is dissolved in the polyol blend.

If a PHD polymer polyol is desired, the PHD forming monomers may include amines, such as ammonia, anilines and substituted anilines, and fatty amines. The PHD forming monomers may also include diamines, such as ethylenediamine, 1,6-hexamethylenediamine, alkonolamines, and hydrazine.

If a PIPA polymer polyol is desired, the PIPA forming monomers may include include diols, such as glycol; and alkanolamines, such as monoethanolamine, diethanolamine, triethanolamine, triisopropanolamine, 2-(2-aminoethoxyethanol), hydroxyethylpiperazine, monoisopropanolamine, diisopropanolamine and mixtures thereof. Other alkanolamines which may be considered include N-methylethanolamine, phenylethanolamine, and glycol amine. It is also possible to provide a mixture of PHD and PIPA forming monomers to form hybrid PHD-PIPA particles.

The at least one PHD and/or PIPA polymer forming monomers are added to the blend in a concentration of between about 2 wt. % and about 40 wt. % of the total polyol blend weight, preferably between about 5 wt. % and about 30 wt. %.

Additionally, catalysts may be combined with the polyol blend. Catalytic quantities of organometallics may be used. Organometallic compounds useful as catalysts include those of bismuth, lead, tin, titanium, iron, antimony, uranium, cadmium, cobalt, thorium, aluminum, mercury, zinc, nickel, cerium, molybdenum, vanadium, copper, manganese, zirconium, etc. Some examples of these metal catalysts include bismuth nitrate, bismuth neodecanoate, lead 2-ethylhexoate, lead benzoate, lead oleate, dibutyltin dilaurate, tributyltin, butyltin trichloride, stannic chloride, stannous octoate, stannous oleate, dibutyltin di(2-ethylhexoate), ferric chloride, antimony trichloride, antimony glycolate, tin glycolates, iron acetyl acetonate etc. The catalyst may accelerate the reaction of diisocyanate with the primary hydroxyl groups of the alkanolamines.

Under stirring, at least one isocyanate is added to the polyol blend. Stirring may be produced in stirred reactors or by using static mixers in series, as is know in the art. Isocyanates which may be used in the present invention include aliphatic, cycloaliphatic, arylaliphatic and aromatic isocyanates.

Examples of suitable aromatic isocyanates include the 4,4′-, 2,4′ and 2,2′-isomers of diphenylmethane diisocyante (MDI), blends thereof and polymeric and monomeric MDI blends, toluene-2,4- and 2,6-diisocyanates (TDI), m- and p-phenylenediisocyanate, chlorophenylene-2,4-diisocyanate, diphenylene-4,4′-diisocyanate, 4,4′-diisocyanate-3,3′-dimethyldiphenyl, 3-methyldiphenyl-methane-4,4′-diisocyanate and diphenyletherdiisocyanate and 2,4,6-triisocyanatotoluene and 2,4,4′-triisocyanatodiphenylether.

Mixtures of isocyanates may be used, such as the commercially available mixtures of 2,4- and 2,6-isomers of toluene diisocyantes. A crude polyisocyanate may also be used in the practice of this invention, such as crude toluene diisocyanate obtained by the phosgenation of a mixture of toluene diamine or the crude diphenylmethane diisocyanate obtained by the phosgenation of crude methylene diphenylamine. TDI/MDI blends may also be used.

Examples of aliphatic polyisocyanates include ethylene diisocyanate, 1,6-hexamethylene diisocyanate, isophorone diisocyanate, cyclohexane 1,4-diisocyanate, 4,4′-dicyclohexylmethane diisocyanate, saturated analogues of the above mentioned aromatic isocyanates and mixtures thereof.

The at least one isocyanate is added to the polyol blend for an isocyanate index of between about 30 and about 150, preferably between about 50 and about 120, more preferably between about 60 and about 110. The isocyanate index is the ratio of isocyanate-groups over isocyanate-reactive hydrogen atoms present in a formulation, given as a percentage. Thus, the isocyanate index expresses the percentage of isocyanate actually used in a formulation with respect to the amount of isocyanate theoretically required for reacting with the amount of isocyanate-reactive hydrogen used in a formulation.

The at least one PHD and/or PIPA polymer forming monomers and isocyanate may be successfully reacted without the application of external heat and atmospheric pressure, although higher temperatures and pressures may also be acceptable. For example, the reaction temperature could range between about 25° C. and about 100° C., and the pressure may range from atmospheric to about 100 psig.

The vinyl polymer, PHD, and/or PIPA natural oil based polymer polyols (NOBPP) may have a vinyl polymer, PHD, and/or PIPA polymer solids content within the range between about 1 wt. % and about 40 wt. %, preferably, between about 10 wt. % and 30 wt. %, based on the total weight of the vinyl polymer, PHD, and/or PIPA NOBPP. The PHD and/or PIPA polymer solids may have average particle size diameters below about 10 μm, preferably below about 5 μm, as measured in accordance to ASTM D1921. In an embodiment, the average particle size diameter is between about 0.1 μm and about 5 μm.

Because the vinyl polymer, PHD, and/or PIPA polymer solids have been formed in a polyol blend that includes at least polyether natural oil based polyol (PNOBP), the polymer solids may have PNOBP grafted to the solid particles. Although, in the case of PIPA and PHD particles, the PNOBP may react with the isocyanate more slowly than the PHD and/or PIPA forming monomers react, a certain percentage of the total mass of the polymer solids will include the PNOBP. Additionally, upon formation of the vinyl polymer, PHD, and/or PIPA polymer particles, the particles may encapsulate a certain amount of the natural oil derived polyol. On average, each polymer solid particle may include between about 1 wt. % and about 20 wt. % PNOBP. The formation of particles in the presence of the PNOBP therefore increases the amount of renewable resources used in developing the end product, as part of the vinyl polymer, PHD, and/or PIPA polymer solids consists of a renewable resource.

Furthermore, many conventional polyols may not be miscible or otherwise compatible natural oil derived polyols. However, just as the PHD and/or PIPA particles may have natural oil derived polyol grafted to the solid particles, the particles may also be grafted with conventional petroleum-based polyol, provided such conventional petroleum-based polyols are included in the polyol blend. Thus, because the particles include both natural oil derived polyol moieties and conventional petroleum-based moieties, the particles may enhance the miscibility of the otherwise incompatible polyols.

The viscosity of the NOBPP may be less than 20,000 cps, is preferably less than 12,000 cps, and preferably less than 8000 cps, measured at 25° C. in accordance to the ISO 3219 method.

The polymer polyol prepared from the above ingredients may then be incorporated into a formulation which results in a polyurethane product. The NOBPP embodied herein may be used in conjunction with an isocyanate such as those mentioned above or may be combined with additional polyols well known in the art, and reacted with an isocyanate to form a resulting polyurethane foam product.

Among the advantages of the polyurethane foams produced with the NOBPP described herein include providing foams that are made with a high level of renewable resources while still retaining similar load bearing properties, aging characteristics, and elasticity as foams produced using less or no renewable resources. Additionally, these foams may also demonstrate improved humid ageing and wet compression set properties.

In general, the polyurethane foams are prepared by mixing an isocyanate, such as the isocyanates listed above, or combinations thereof, and the NOBPP in the presence of a blowing agent, catalyst(s) and other optional ingredients as desired. Additional polyols and/or polymer polyols may also be added to the polymer polyol blend before the polymer polyol composition is reacted with the isocyanate. The conditions for the reaction are such that the polyisocyanate and polyol composition react to form a polyurethane and/or polyurea polymer while the blowing agent generates a gas that expands the reacting mixture.

The polymer polyol blend reacted with isocyanate to produce the polyurethane foam may have a concentration of a natural oil derived polyol of between about 10 wt. % and about 90 wt. %, preferably between about 20 wt. % and about 50 wt. %. In one embodiment the concentration is about 45 wt. %. The blend may have a total solids content (including vinyl polymer, PIPA and/or PHD solids) of between about 5 wt. % and about 50 wt. % or more, based on the total mass of the blend. In one embodiment the content is about 40 wt. %.

The polymer polyol blend may also be combined with a conventional petroleum based polyol such as those described above after the formation of the polymer particles and before using the blend in a foaming formulation. Additionally, the polymer blend may also be combined with a conventional petroleum based polymer polyol, such as styrene-acrylonitrile (SAN), acrylonitrile (ACN), polystyrene (PS), methacrylonitrile (MAN), or methyl methacrylate (MMA) polymer polyol.

The blend may also include one or more catalysts for the reaction of the polyol (and water, if present) with the polyisocyanate. Any suitable urethane catalyst may be used, including tertiary amine compounds, amines with isocyanate reactive groups and organometallic compounds. Exemplary tertiary amine compounds include triethylenediamine, N-methylmorpholine, N,N-dimethylcyclohexylamine, pentamethyldiethylenetriamine, tetramethylethylenediamine, bis (dimethylaminoethyl)ether, 1-methyl-4-dimethylaminoethyl-piperazine, 3-methoxy-N-dimethylpropylamine, N-ethylmorpholine, dimethylethanolamine, N-cocomorpholine, N,N-dimethyl-N′,N′-dimethyl isopropylpropylenediamine, N,N-diethyl-3-diethylamino-propylamine and dimethylbenzylamine. Exemplary organometallic catalysts include organomercury, organolead, organoferric and organotin catalysts, with organotin catalysts being preferred among these. Suitable tin catalysts include stannous chloride, tin salts of carboxylic acids such as dibutyltin di-laurate. A catalyst for the trimerization of isocyanates, resulting in a isocyanurate, such as an alkali metal alkoxide may also optionally be employed herein. The amount of amine catalysts can vary from 0.02 to 5 percent in the formulation or organometallic catalysts from 0.001 to 1 percent in the formulation can be used.

Additionally, it may be desirable to employ certain other ingredients in preparing polyurethane polymers. Among these additional ingredients are emulsifiers, silicone surfactants, preservatives, flame retardants, colorants, antioxidants, reinforcing agents, fillers, including recycled polyurethane foam in form of powder.

The foam may be formed by the so-called prepolymer method, in which a stoichiometric excess of the polyisocyanate is first reacted with the high equivalent weight polyol(s) to form a prepolymer, which is in a second step reacted with a chain extender and/or water to form the desired foam. Frothing methods may also be suitable. So-called one-shot methods, may also be used. In such one-shot methods, the isocyanate and all isocyanate-reactive components are simultaneously brought together and caused to react. Three widely used one-shot methods which are suitable for use herein include slabstock foam processes, high resiliency slabstock foam processes, and molded foam methods.

Slabstock foam may be prepared by mixing the foam ingredients and dispensing them into a trough or other region where the reaction mixture reacts, rises freely against the atmosphere (sometimes under a film or other flexible covering) and cures. In common commercial scale slabstock foam production, the foam ingredients (or various mixtures thereof) are pumped independently to a mixing head where they are mixed and dispensed onto a conveyor that is lined with paper or plastic. Foaming and curing occurs on the conveyor to form a foam bun. The resulting foams are typically from about from about 10 kg/m³ to 80 kg/m³, especially from about 15 kg/m³ to 60 kg/m³, preferably from about 17 kg/m³ to 50 kg/m³ in density.

A slabstock foam formulation may contain from about 3 to about 6, preferably about 4 to about 5 parts by weight water are used per 100 parts by weight high equivalent weight polyol at atmospheric pressure. At reduced pressure these levels are reduced.

High resilience slabstock (HR slabstock) foam may be made in methods similar to those used to make conventional slabstock foam but using higher equivalent weight polyols. HR slabstock foams are characterized in exhibiting a Ball rebound score of 45% or higher, per ASTM 3574.03. Water levels tend to be from about 2 to about 6, especially from about 3 to about 5 parts per 100 parts (high equivalent) by weight of polyols.

Molded foam can be made according to the invention by transferring the reactants (polyol composition including copolyester, polyisocyanate, blowing agent, and surfactant) to a closed mold where the foaming reaction takes place to produce a shaped foam. Either a so-called “cold-molding” process, in which the mold is not preheated significantly above ambient temperatures, or a “hot-molding” process, in which the mold is heated to drive the cure, can be used. Cold-molding processes are preferred to produce high resilience molded foam. Densities for molded foams generally range from 30 to 50 kg/m³.

The foams made using NOBPP have improved humid aged hardness change as determined by DIN EN ISO 2440. According to this method, hardness, or Compression Force Deflection (CFD), is measured on a sample according to ISO 3386. Then the sample is aged for a specified time (5 hrs), s specified temperature (120° C.), and specified humidity (100%). The sample is then dried (3 hrs at 70° C.) and the hardness measured again. The difference between the two numbers (delta) is used to calculate the percent change of hardness. The foams made using NOBPP may have a humid aged hardness change of less than about 40%, such as less than about 39, 38, 37, 36, 35, 34, 33, 32, 31, 30, 29, 28, or 27%.

The foams made using NOBPP may have resiliencies as determined by ASTM D3574 above about 25, 30, 35, 40, 45, 50, 51, 52, 53, or 54%. In one embodiment the resiliency may be between about 40 and about 54%.

The foams made using NOBPP may have renewable carbon contents above about 1% based on the total carbon content of the foams. The renewable carbon content may be above about 2%, 5%, 7%, 10%, 12%, 13%, 14%, 15%, 16%, 17%, 18%, 18.5%, 19%, 20%, or 25%. The renewable carbon contents of the foams may be calculated and/or measured as described in PU Magazine, Vol. 5, No. 6, December 2008, pages 368-372.

The applications for foams produced by processes described herein are those known in the industry. Flexible, semi-rigid and viscoelastic foams find use in applications such as furniture, shoe soles, automobile seats, sun visors, steering wheels, packaging applications, armrests, door panels, noise insulation parts, other cushioning and energy management applications, carpet backing, dashboards and other applications for which conventional flexible polyurethane foams are used. Other applications include coatings, adhesives, and elastomers.

### EXAMPLES

The following examples are provided to illustrate the embodiments of the invention, but are not intended to limit the scope thereof. All parts and percentages are by weight unless otherwise indicated.

The following materials were used:
PNOBP A: A soybean oil based polyol prepared according to Example 6 of copending Patent Application No. PCT/US09/37751, filed on Mar. 20, 2009, entitled “Polyether Natural Oil Polyols and Polymers Thereof” the entire contents of which are incorporated herein by reference. PNOBP A has a hydroxyl number of 29.
PNOBP B: A soybean oil based polyol prepared according to Example 7 of copending Patent Application No. PCT/US09/37751, filed on Mar. 20, 2009, entitled “Polyether Natural Oil Polyols and Polymers Thereof” the entire contents of which are incorporated herein by reference. PNOBP B has a hydroxyl number of 27.
BIOH: A soybean oil based polyol available from Cargill under the name BIOH.
Triethanolamine: Above 98% purity, available from the Sigma-Aldrich Co.
VORANATE T-80: A toluene diisocyanate (80% 2,4-toluene diisocyanate and 20% 2,6-toluene diisocyanate by weight) composition available from The Dow Chemical Company.
DABCO T9: A stannous octoate catalyst available from Air Products & Chemicals Inc
DABCO T-12: A tin catalyst available from Air Products & Chemicals Inc.
DABCO MB20: A bismuth neodecanoate catalyst available from Air Products & Chemicals Inc.
VORANOL 4820: A 5,000 MW polyether polyol initiated with glycerol using an EO/PO mixed feed, and having a hydroxyl number range of 34-38, available from The Dow Chemical Company.
SPECFLEX NC 700: A grafted polyether polyol containing 40% copolymerized styrene and acrylonitrile (SAN). Available from The Dow Chemical Company.
Diethanolamine: Available from the Sigma-Aldrich Co.
NIAX L-2100: A silicone surfactant available from Momentive Performance Materials.
NIAX A-1: A tertiary amine catalyst available from Momentive Performance Materials.
DABCO 33LV: A 33% solution of Triethylenediamine in propylene glycol available from Air Products & Chemicals Inc.
ORTEGOL 204: A block stabilizer available from Evonik Industries.
KOSMOS 54: A zinc ricinoleate catalyst available from Evonik Industries.

### PIPA Polyols (Examples E1-E9 and Comparative Examples CE1-CE3)

PIPA polyols were made by first adding either PNOBP A (Examples E1-E7), PNOBP B (Examples E8-E9), BIOH (Comparative Examples CE1-CE2), or VORANOL 4820 (Comparative Example CE3) to an empty container. Triethanolamine was then added and the two components mixed for two minutes at about 1500 rpm. While continuing the stirring, VORANATE T-80 was added and the reaction mixture stirred for 30 seconds. Then, either DABCO T12 or DABCO MB20 was added and the stirring continued for two minutes. The container was covered and let cool to room temperature. The materials, and the amounts (in grams), used are given in Table 1, along with the resulting viscosities of the resulting PIPA polyols and average particle diameters of the PIPA particles.

TABLE 1

| | | E1 | E2 | E3 | E4 | E5 | E6 | E7 | E8 | E9 | CE1 | CE2 | CE3 |
|---|---|---|---|---|---|---|---|---|---|---|---|---|---|
| PNOBP A (g) | | 900 | 900 | 900 | 900 | 900 | 900 | 900 | | | | | |
| PNOBP B (g) | | | | | | | | | 900 | 900 | | | |
| BIOH (g) | | | | | | | | | | | 900 | 900 | |
| VORANOL 4820 (g) | | | | | | | | | | | | | 900 |
| Triethanolamine (g) | | 46.9 | 46.9 | 46.9 | 46.9 | 46.9 | 46.9 | 46.9 | 46.9 | 46.9 | 46.9 | 46.9 | 46.9 |
| VORANATE T-80 (g) | | 53.1 | 53.1 | 53.1 | 53.1 | 53.1 | 53.1 | 53.1 | 53.1 | 53.1 | 53.1 | 53.1 | 53.1 |
| DABCO T12 (g) | | 0.2 | | | | | 0.2 | | 0.2 | | 0.2 | | |
| DABCO MB20 (g) | | | 0.1 | 0.2 | 0.4 | 0.8 | | 0.2 | | 0.2 | | 0.2 | 0.2 |
| Particle Size | ASTM | 0.76 | 0.58 | 0.89 | 1.04 | 0.36 | 0.41 | 0.68 | 2.33 | 0.41 | 27.06 | 0.17 | 0.17 |
| (μm) | D1921 | | | | | | | | | | | | |
| Viscosity, | ISO | 5490 | 4420 | 4100 | 4800 | 4370 | 6780 | 4500 | 7430 | 4140 | 12000 | 10900 | 4600 |
| 100 s⁻¹ (mPa*s) | 3219 | | | | | | | | | | | | |

### Polyurethane Foam (Foam Examples FE1-FE3 and Foam Comparative Example FCE1-FCE2)

Polyurethane foams are made using the PIPA polyols formed in Example E7 (Foam Examples FE1-FE4) and in Comparative Example CE3 (Foam Comparative Examples FCE1 and FCE2). Additional ingredients for all the examples are VORANATE T-80 at index 110, water (1.5 PHP), Diethanolamine (0.6 PHP), NIAX A-1 (0.1 PHP), DABCO 33 LV (0.15 PHP), NIAX L-2100 (0.8 PHP), ORTEGOL 204 (1.8 PHP), KOSMOS 54 (0.5 PHP), and DABCO T9 (0.1 PHP). The foams are made in the laboratory by preblending the polyols given in Table 2 with the additional ingredients, except for VORANATE® T-80, all conditioned at 25° C. The VORANATE® T-80 is also conditioned at 25° C., and is reacted with the polyol preblend to produce a foam. Physical properties of the resulting foams are also given in Table 2.

TABLE 2

| | | FE1 | FE2 | FE3 | FE4 | FCE1 | FCE2 |
|---|---|---|---|---|---|---|---|
| PIPA polyol from E7 (made with PNOBP A) | | 65 | 75 | 85 | 85 | | |
| PIPA polyol from CE3 (made with | | | | | | 65 | |
| VORANOL 4820) | | | | | | | |
| VORANOL 4820 | | 35 | 25 | 15 | | 35 | 80 |
| PNOBP A | | | | | 15 | | |
| SPECFLEX NC 700 | | | | | | | 20 |
| Renewable carbon content (%) | | 13.7 | 15.7 | 17.7 | 18.8 | <1 | <1 |
| Density (kg/m³) | ISO 845-88 | 41.8 | 43.0 | 43.8 | 44.8 | 41.7 | 41.9 |
| CFD 40% (kPa) | ISO 3386 | 2.30 | 2.63 | 3.01 | 2.50 | 2.96 | 2.78 |
| CFD 40% HUMID (kPa) | ISO 3386 | 1.65 | 1.87 | 2.01 | 2.01 | 1.44 | 1.68 |
| Delta (kPa) | ISO 3386 | 0.65 | 0.76 | 1.00 | 0.49 | 1.52 | 1.10 |
| Delta (%) | ISO 3386 | 28.3 | 28.9 | 33.1 | 19.4 | 51.4 | 39.5 |
| Resilience (%) | ASTM D3574 | 56 | 55 | 54 | 54 | 61 | 63 |
| CS 75% (%) | ISO 1856-00 | 6.7 | 7.5 | 7.7 | 9.3 | 4.9 | 4.5 |
| CS 90% (%) | ISO 1856-00 | 7.9 | 9.7 | 9.4 | 13.2 | 6.6 | 5.6 |

From Table 2 it can be seen that foams based on polymer polyols made using polyether natural oil based polyols (Foam Examples FE1-FE4) are high resilience foams that have low humid ageing hardness loss as compared to the foams made from non-PNONP based polymer polyols (Foam Comparative Examples FCE1 and FCE2).

1. A polymer polyol, comprising:
a polyol; and
dispersed polymer particles, wherein the polyol includes at least one polyether natural oil based polyol comprising at least two natural oil moieties separated by at least one of a molecular structure having an average of at least about 19 ether groups between any 2 of the natural oil moieties and a polyether molecular structure having an equivalent weight of at least about 400.

2. The polymer polyol of claim 1, wherein the dispersed polymer particles comprises particles grafted with the at least one polyether natural oil based polyol.

3. The polymer polyol of claim 2, wherein the dispersed polymer particles comprises at least one of acrylonitrile, polystyrene, methacrylonitrile, methyl methacrylate, styrene-acrylonitrile, a polyurea, and a polyurethane-urea.

4. The polymer polyol of claim 2, wherein the dispersed polymer particles comprises a polyurethane-urea.

5. The polymer polyol of claim 4, wherein the polymer polyol has a viscosity between about 3000 mPa*s and about 8000 mPa*s in accordance to ISO 3219.

6. The polymer polyol of claim 4, wherein the dispersed polymer particles have an average particle diameter between about 0.1 μm and about 5 μm.

7. A polyurethane foam, comprising a reaction product of at least:
an isocyanate; and
the polymer polyol of claim 1.

8. The polyurethane foam of claim 7, wherein the polyurethane foam has a resilience of at least about 50% and a humid aged hardness loss of less than about 40%, in accordance to DIN EN ISO 2440.

9. A polyurethane foam, comprising a reaction product of at least an isocyanate and a polyol, wherein the polyurethane foam has a resilience of at least about 50% and a humid aged hardness loss of less than about 40%, in accordance to DIN EN ISO 2440.

10. The polyurethane foam of claim 8, wherein the polyurethane foam has a humid aged hardness loss of less than about 39%, in accordance to DIN EN ISO 2440.

11. The polyurethane foam of claim 7, wherein the polyurethane foam comprises at least 13% renewable carbon content.

12. An article of manufacture, comprising the polyurethane foam of claim 7.

13. A method of forming a polymer polyol, comprising:
providing a polyol composition comprising at least one polyether natural oil based polyol comprising at least two natural oil moieties separated by at least one of a molecular structure having an average of at least about 19 ether groups between any 2 of the natural oil moieties and a polyether molecular structure having an equivalent weight of at least about 400; and
forming at least one polymer particle population of at least one of acrylonitrile, polystyrene, methacrylonitrile, methyl methacrylate, styrene-acrylonitrile, polyurea, and polyurethane-urea in the polyol composition.

14. The method of claim 13, wherein the forming at least one polymer particle population comprises:
combining monomers of at least one of a diamine, ammonia, a hydrazine, a glycol, or alkanolamine with the polyol composition; and
adding at least one first isocyanate to the polyol blend.

15. The method of claim 13, wherein the forming at least one polymer particle population comprises:
combining one or more ethylenically unsaturated monomer and at least one stabilizer with the polyol composition to form a mixture, and subjecting the mixture to conditions sufficient to polymerize the ethylenically unsaturated monomer to form dispersed polymer particles.

16. The method of claim 13, wherein the at least one first isocyanate is at least one of toluene diisocyanate and diphenylmethane diisocyante.

17. The polymer polyol of claim 1, wherein the polyether molecular structure has an equivalent weight of at least about 480.
